(19) United States
(12) Patent Application Publication
(10) Pub. No.: US 2018/0136352 A1
(43) Pub. Date: May 17, 2018

(54) VIBRATION-ANALYSIS SYSTEM AND METHOD THEREFOR

(71) Applicant: Symroc Business and Project Management Ltd., Calgary (CA)

(72) Inventor: Wilson HOWE, Calgary (CA)

(21) Appl. No.: 15/813,087

(22) Filed: Nov. 14, 2017

(30) Foreign Application Priority Data
Nov. 14, 2016 (CA) 2948437
May 19, 2017 (CA) 2967629

(51) Int. Cl. G01V 1/36; G01V 1/18

(52) U.S. Cl. CPC G01V 1/364; G01V 1/181

(57) ABSTRACT

A vibration-analysis system has one or more server computers, one or more client-computing devices, and one or more vibration-detection units functionally connected via a network. The one or more vibration-detection units may be deployed in a site for vibration detection. The detected vibration data is sent to the one or more server computers for vibration/seismic analysis. The system disclosed herein may be used for vibration/seismic survey, vibration monitoring, and the like. Each vibration-detection unit may have a vibration-detection sensor and a positioning module for automatically determining the position thereof. The vibration-detection units may be geophones and the system may have a signal process module for compensating for the distortion introduced by the geophones.

### CROSS-REFERENCE TO RELATED APPLICATIONS

This application claims the benefit of Canadian Patent Application Serial No. 2,948,437, filed Nov. 14, 2016, and Canadian Patent Application Serial No. 2,967,629, filed May 19, 2017, the content of each of which is incorporated herein by reference in its entirety.

### FIELD OF THE DISCLOSURE

The present disclosure relates generally to vibration-analysis systems and methods, and in particular, to systems and methods for analyzing vibration and/or seismic data obtained from vibration detection devices such as geophones.

### BACKGROUND

Seismicity involves earthquake occurrences, mechanisms, and magnitude at a given geographical location, and summarizes a region's seismic activity (see Physics of the Earth (4th edition), by Frank D. Stacey and Paul M. Davis, published by Cambridge University Press, September 2008, ISBN: 9780521873628). Seismicity may be categorized as natural seismicity such as naturally occurring earthquakes, and induced seismicity such as earthquakes and tremors caused by human activity. Most induced seismicity is of low magnitudes.

Seismic survey has been widely used in many areas such as, for example, resource exploration. Seismic survey detects seismic signals generated from a remote man-made seismic source and propagated through the earth. The detected signal may be used for seismic data analysis such as for generating two-dimensional (2D) and/or three-dimensional (3D) seismic images or time-lapse seismic images which may be considered as four-dimensional (4D) images.

Ground vibrations are usually man-made vibrations of the ground caused by explosions, construction work, railway and road transport, and the like. Ground vibrations may have a wide range of frequencies, and usually cause acoustic waves travelling along ground surfaces.

Topography is the study of the shape and features of the earth's surfaces and other observable astronomical objects. The topography of an area commonly refers to three-dimensional ground surface shapes.

Various vibration sensors such as geophones and micro-electromechanical systems (MEMS) sensors have been used in seismic surveys. For example, a geophone generally comprises one or more coils suspended in a magnetic field. An external vibration causes the coils to move in the magnetic field and develop an electronic voltage across the coil terminals. Such electronic voltages may be used for determining the characteristics of the external vibration.

Conventional geophones are usually low cost, power efficient and reliable. However, their frequency bandwidth is generally narrow. In particular, conventional geophones usually have poor frequency response at low frequency ranges. Open-loop MEMS sensors generally have a very limited frequency bandwidth. On the other hand, closed-loop MEMS sensors are usually expensive, fragile, and power inefficient.

### SUMMARY

According to one aspect of this disclosure, there is provided a vibration-detection apparatus. The vibration-detection apparatus comprises: a geophone for detecting vibration and outputting a first signal; an analog-to-digital (A/D) converter functionally coupled to the geophone for converting the first signal to a second signal in a discrete-time domain; and a signal-processing module functionally coupled to the geophone for processing the second signal in discrete-time to compensate for the distortion therein introduced by the geophone. The geophone has a s-domain transfer function H(s) of

$$H ( s ) = B \frac{{s}^{2}}{{s}^{2} + 2 {ξω}_{n} s + {ω}_{n}^{2}}$$

where B, ωₙ, and ξ are predetermined parameters. The signal-processing module has a z-domain transfer function G(z) obtained from a s-domain transfer function of

$$G ( s ) = \frac{{s}^{2} + 2 {ξω}_{n} s + {ω}_{n}^{2}}{{Bs}^{2}}$$

using a predetermined sampling method with a predetermined sampling frequency.

In some embodiments, the signal-processing module is a digital filter having a plurality of amplifiers and unit delays; and the signal-processing module has a z-domain transfer function G(z) as

$$G ( z ) = \frac{{b}_{0} + {b}_{1} {z}^{- 1} + {b}_{2} {z}^{- 2}}{1 + {a}_{1} {z}^{- 1} + {a}_{2} {z}^{- 2}}$$

where a₀, a₁, a₂, b₀, b₁, and b₂ are gains of the amplifiers and are predetermined based on H(s), the sampling method and the sampling frequency.

In some embodiments, the vibration-detection apparatus further comprises: a positioning module; a network module; and a control circuit functionally coupled to the geophone, the signal-processing module, the positioning module and the network module for controlling the operation thereof.

In some embodiments, the positioning module is a Global Positioning System (GPS) module.

According to one aspect of this disclosure, there is provided a vibration-detection system. the vibration-detection system comprises: at least one server computer; one or more vibration-detection units functionally coupled to the at least one server computer via a network, each vibration-detection unit for detecting vibration and outputting vibration data, each vibration-detection unit comprising at least a geophone and an A/D converter functionally coupled to the geophone for converting the output signal of the geophone to a second signal in a discrete-time domain, the vibration-detection unit generating the vibration data based on the second signal; and at least one signal-processing module functionally coupled to the geophone for processing the first signal in discrete-time to compensate for the distortion therein introduced by the geophone. Each geophone has a s-domain transfer function H(s) of

$$H ( s ) = B \frac{{s}^{2}}{{s}^{2} + 2 {ξω}_{n} s + {ω}_{n}^{2}}$$

where B, ωₙ, and ξ are predetermined parameters. The at least one signal-processing module has a z-domain transfer function G(z) obtained from a s-domain transfer function of

$$G ( s ) = \frac{{s}^{2} + 2 {ξω}_{n} s + {ω}_{n}^{2}}{{Bs}^{2}}$$

using a predetermined sampling method with a predetermined sampling frequency.

In some embodiments, the vibration-detection system further comprises: one or more data hubs, each of the one or more data hubs functionally coupled to at least one vibration-detection unit for collecting the vibration data and forwarding the collected vibration data to the at least one server computer.

In some embodiments, the vibration-detection system further comprises: one or more client-computing devices functionally coupled to the at least one server computer.

In some embodiments, each of the vibration-detection units comprises one of the at least one signal-processing module.

In some embodiments, each of the at least one signal-processing module is a digital filter having a plurality of amplifiers and unit delays; and the signal-processing module has a z-domain transfer function G(z) of

$$G ( z ) = \frac{{b}_{0} + {b}_{1} {z}^{- 1} + {b}_{2} {z}^{- 2}}{1 + {a}_{1} {z}^{- 1} + {a}_{2} {z}^{- 2}}$$

where a₀, a₁, a₂, b₀, b₁, and b₂ are gains of the amplifiers and are predetermined based on H(s), the sampling method and the sampling frequency.

In some embodiments, the signal-processing module comprises computer-executable code executable by the at least one server computer.

In some embodiments, each vibration-detection unit further comprises: a positioning module; a network module; and a control circuit functionally coupled to the geophone, the signal-processing module, the positioning module and the network module for controlling the operation thereof.

In some embodiments, the positioning module is a GPS module.

According to one aspect of this disclosure, there is provided a computer-readable storage device comprising computer-executable instructions for processing an output signal of a geophone for compensating for the distortion therein introduced by the geophone, each geophone having a s-domain transfer function H(s) of

$$H ( s ) = B \frac{{s}^{2}}{{s}^{2} + 2 {ξω}_{n} s + {ω}_{n}^{2}}$$

where B, ωₙ, and ξ are predetermined parameters. The instructions, when executed, cause a processor to act as a digital filter having a z-domain transfer function G(z) obtained from a s-domain transfer function of

$$G ( s ) = \frac{{s}^{2} + 2 {ξω}_{n} s + {ω}_{n}^{2}}{{Bs}^{2}}$$

using a predetermined sampling method with a predetermined sampling frequency.

In some embodiments, the instructions, when executed, cause the processor to further cause the processor to perform actions comprising: obtaining the position information of the geophone; identifying the geophone; and determining the transfer function G(s) based on said identification.

In some embodiments, each geophone is associated with a positioning module; and wherein said obtaining the position information of the geophone comprises obtaining the position information of the geophone by using the positioning module associated therewith.

In some embodiments, the positioning module is a GPS module.

According to one aspect of this disclosure, there is provided a computerized method for conducting a seismic survey in a site. The method comprises: deploying one or more vibration-detection units in the site for generating vibration data; collecting vibration data from at least one of the one or more vibration-detection units; compensating for the distortion in the collected vibration data; and analyzing the compensated vibration data for the seismic survey. The step of compensating for the distortion in the collected vibration data comprises: for each of the at least one of the one or more vibration-detection units, obtaining the position information of the vibration-detection unit; identifying the vibration-detection unit; determining a transfer function of a signal-processing module for the vibration-detection unit based on said identification; and using the signal-processing module to compensate for the distortion in the vibration data generated by the vibration-detection unit.

In some embodiments, each vibration-detection unit comprises a positioning module; and the step of obtaining the position information of the vibration-detection unit comprises: obtaining the position information of the vibration-detection unit from the positioning module thereof.

In some embodiments, the positioning module is a GPS module.

In some embodiments, each vibration-detection unit comprises a geophone having a s-domain transfer function H(s) of

$$H ( s ) = B \frac{{s}^{2}}{{s}^{2} + 2 {ξω}_{n} s + {ω}_{n}^{2}}$$

where B, ωₙ, and ξ are predetermined parameters; and the transfer function of the signal-processing module is a z-domain transfer function G(z) obtained from a s-domain transfer function of

$$G ( s ) = \frac{{s}^{2} + 2 {ξω}_{n} s + {ω}_{n}^{2}}{{Bs}^{2}}$$

using a predetermined sampling method with a predetermined sampling frequency.

### BRIEF DESCRIPTION OF THE DRAWINGS

FIG. 1 is a schematic diagram of a vibration-analysis system, according to some embodiments of the present disclosure;

FIG. 2 shows the hardware structure of a computing device of the vibration-analysis system shown in FIG. 1;

FIG. 3 shows a simplified software architecture of a computing device of the vibration-analysis system shown in FIG. 1;

FIG. 4 shows the hardware structure of a vibration-detection unit of the vibration-analysis system shown in FIG. 1;

FIG. 5 is a flowchart showing the steps of a vibration/seismic survey and/or monitoring process executed by the vibration-analysis system shown in FIG. 1;

FIG. 6 is a block diagram showing a geophone coupled to a signal-processing module in the vibration-analysis system shown in FIG. 1, wherein the signal-processing module processes the output signal of the geophone for compensating for the distortion introduced by the geophone;

FIG. 7A is a schematic perspective view of a geophone of the vibration-analysis system shown in FIG. 1;

FIG. 7B is a schematic cross-sectional view of the geophone shown in FIG. 7A along the section line A-A;

FIG. 7C is a block diagram showing an electrical model of the geophone shown in FIG. 7A;

FIG. 8A shows a sinusoid input signal x(t)=sin(2πf₀t) with a frequency f₀ of 31.25 Hz input to the geophone shown in FIG. 7A, and the output y(t) thereof, according to a first example;

FIG. 8B shows a sinusoid input signal x(t)=sin(2πf₀t) with a frequency f₀ of 2 Hz input to the geophone shown in FIG. 7A, and the output y(t) thereof in the first example;

FIGS. 9A and 9B show the Bode diagram of the transfer function H(s) of the geophone shown in FIG. 7A in the first example;

FIG. 10 is a block diagram showing an s-domain model of an equalized geophone of the vibration-analysis system shown in FIG. 1, wherein the equalized geophone comprises a geophone and a signal-processing module processing the output signal of the geophone for compensating for the distortion introduced by the geophone;

FIG. 11 shows a sinusoid input signal x(t)=sin(2πf₀t) with a frequency f₀ of 2 Hz input to the equalized geophone shown in FIG. 10, according to a second example;

FIG. 12 shows the Bode diagram of the transfer function Hₒ(s) of the equalized geophone shown in FIG. 10 in the second example;

FIG. 13 is a block diagram showing a discrete-time model of the equalized geophone shown in FIG. 10;

FIG. 14 is a block diagram showing a direct-form II closed-loop digital filter implementation of signal-processing module of the equalized geophone shown in FIG. 13;

FIG. 15 shows a sinusoid input signal x(n)=sin(2πf₀n) with a frequency f₀ of 2 Hz input to the equalized geophone shown in FIG. 13, according to a third example;

FIG. 16 shows a sinusoid input signal x(n)=sin(2πf₀n) with a frequency f₀ of 2 Hz input to the equalized geophone shown in FIG. 13, and the equalized output y₀(n) thereof, according to a fourth example;

FIG. 17 shows the Bode diagram of the transfer function Hₒ(s) of the equalized geophone shown in FIG. 13 in the fourth example;

FIG. 18 shows a sinusoid input signal x(t)=sin(2πf₀t) with a frequency f₀ of 2 Hz input to the equalized geophone shown in FIG. 13, and the equalized output y₀ (t) thereof, according to a fifth example;

FIG. 19 shows the Bode diagram of the transfer function Hₒ(s) of the equalized geophone shown in FIG. 13 in the fifth example;

FIG. 20 shows a sinusoid input signal x(t)=sin(2πf₀t) with a frequency f₀ of 2 Hz input to the equalized geophone shown in FIG. 13, and the equalized output y₀(t) thereof, according to a sixth example for testing the impact of a −2.5% error in the damping coefficient ξ of the signal-processing module in the equalized geophone;

FIG. 21 shows the Bode diagram of the transfer function Hₒ(s) of the equalized geophone shown in FIG. 13 in the sixth example for testing the impact of a −2.5% error in the damping coefficient ξ of the signal-processing module in the equalized geophone;

FIG. 22 shows a sinusoid input signal x(t)=sin(2πf₀t) with a frequency f₀ of 2 Hz input to the equalized geophone shown in FIG. 13, and the equalized output y₀(t) thereof, according to a seventh example for testing the impact of a 2.5% error in the damping coefficient ξ of the signal-processing module in the equalized geophone;

FIG. 23 shows the Bode diagram of the transfer function Hₒ(s) of the equalized geophone shown in FIG. 13 in the seventh example for testing the impact of a 2.5% error in the damping coefficient ξ of the signal-processing module in the equalized geophone;

FIGS. 24A to 24D show the simulation results for a ±2.5% error in the resonant frequency fₙ of the signal-processing module in the equalized geophone shown in FIG. 13;

FIG. 25 shows an example of a piece of code written in MATLAB® for implementing the signal-processing module for the geophone in the first example with a sampling frequency of 1000 Hz, and for testing the signal-processing module using a sinusoid input signal;

FIG. 26 shows the input signal and the simulated output signal of the signal-processing module implemented using the code shown in FIG. 25;

FIGS. 27 and 28 respectively show a diagram of simulating the signal-processing module in SIMULINK® (SIMULINK is a registered trademark of MathWorks Inc., Natick, Mass., USA) with a sampling frequency of 1000 Hz, and the simulation results thereof;

FIGS. 29 and 30 respectively show a diagram of simulating the equalized geophone (comprising the geophone and the signal-processing module) in SIMULINK® with a sampling frequency of 1000 Hz, and the simulation results thereof; and

FIG. 31 is a flowchart showing the steps of a vibration/seismic survey or monitoring process executed by the vibration-analysis system shown in FIG. 1, according to some alternative embodiments.

### DETAILED DESCRIPTION

Embodiments herein disclose a vibration-analysis system having one or more server computers, one or more client-computing devices, and one or more vibration-detection units, all functionally connected via a network. The one or more vibration-detection units may be deployed in a site for detection of vibrations. The detected vibration data are sent to the one or more server computers for vibration/seismic analysis. The system disclosed herein may be used for vibration/seismic survey, vibration monitoring, and the like.

In some embodiments, the vibration-analysis system also comprises one or more data hubs, each functionally coupled to one or more vibration-detection units. The data hub collects vibration data from the vibration-detection units and transmits the collected vibration data to the server computer.

In some embodiments, each vibration-detection unit comprises a vibration-detection sensor and a positioning module such as a Global Positioning System (GPS) module for automatically determining the position or geolocation of the vibration-detection unit, thereby avoiding the manual recording and/or updating of the geolocations of the vibration-detection units during their deployment and re-deployment.

In some embodiments, the vibration-detection units are geophones and the system comprises a signal-processing module for compensating for the distortion introduced by the geophones. In some embodiments, the signal-processing module may be implemented as a digital filter. In some other embodiments, the signal-processing module may be implemented as a signal-processing firmware or software program acting as a digital filter. The digital filter or the signal-processing program may be implemented in the vibration-detection unit, in the data hub, and/or in the server computer.

With the signal-processing module, the effective vibration-detection unit, that is, the combination of the geophone and the signal-processing module, provides high-bandwidth (such as from about 0.001 Hz to about 420 Hz) high-accuracy vibration detection results with the capability of detecting low-frequency seismicity, mid-range and high-frequency seismic and vibration signals.

The vibration-detection units may be deployed in the site individually or in an independent array arrangement. Each vibration-detection unit may operate independently within an independent array arrangement. In various embodiments, the vibration-detection units may be field-operated or remotely-controlled to continuously or intermittently collect, store, and transmit vibration data to the server computer for automatic data processing, recognition, and generate visualization with an integrated map interface.

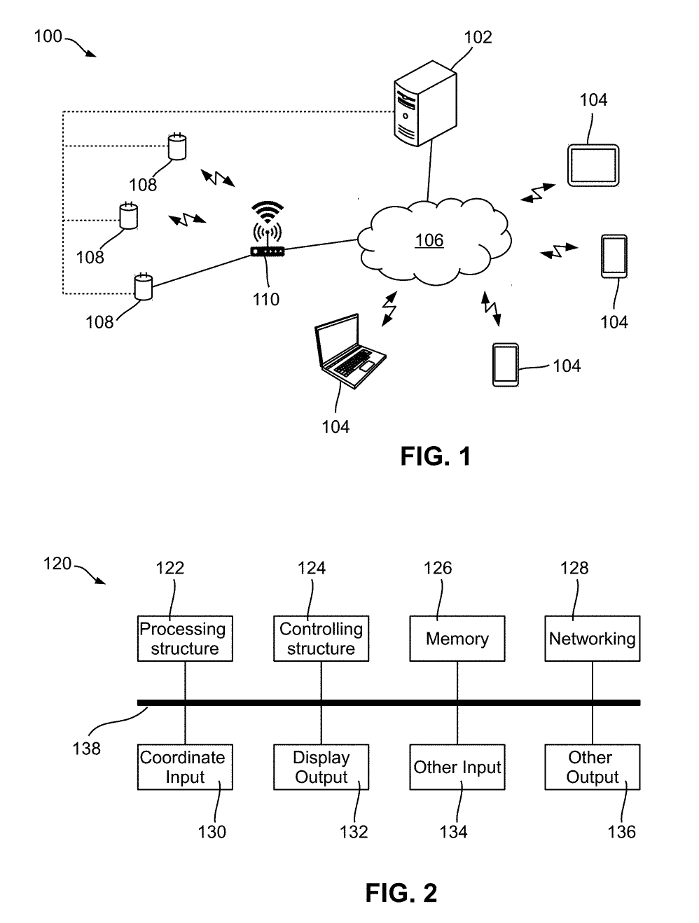

Turning now to FIG. 1, a vibration-analysis system is shown, and is generally identified using reference numeral 100. In these embodiments, the vibration-analysis system 100 receives vibration data from a plurality of vibration-detection units, and uses the received vibration data for vibration analysis.

As shown in FIG. 1, the vibration-analysis system 100 comprises a server computer 102 and one or more client-computing devices 104 functionally interconnected by a network 106, for example, such as the Internet, a local area network (LAN), a wide area network (WAN), and/or the like, via suitable wired and/or wireless networking connections.

The vibration-analysis system 100 also comprises one or more vibration-detection units 108 such as geophones with suitable wired or wireless communication interfaces for functionally connecting to one or more data hubs 110 via suitable wired and wireless networking connections. The data hubs 110 collect vibration data from the vibration-detection units 108 and transmit the collected data to the server computer 102 via the network 106.

In some embodiments, the server computer 102 may also directly communicate with one or more vibration-detection units 108 for directly collecting vibration data therefrom.

The server computer 102 executes one or more server programs. Depending on implementation, the server computer 102 may be a server computing device and/or a general purpose computing device acting as a server computer while also being used by a user.

Each client-computing device 104 executes one or more client application programs and for users to use. The client-computing devices 104 in these embodiments are preferably portable computing devices such as laptop computers, tablets, smartphones, Personal Digital Assistants (PDAs) and the like. However, those skilled in the art will appreciate that one or more client-computing devices 104 may be non-portable computing devices such as desktop computers in some alternative embodiments.

Generally, the computing devices 102 and 104 have a similar hardware structure such as a hardware structure 120 shown in FIG. 2. As shown, the computing device 102/104 comprises a processing structure 122, a controlling structure 124, a memory or storage 126, a networking interface 128, a coordinate input 130, a display output 132, and other input and output modules 134 and 136, all functionally interconnected by a system bus 138.

The processing structure 122 may be one or more single-core or multiple-core computing processors such as INTEL® microprocessors (INTEL is a registered trademark of Intel Corp., Santa Clara, Calif., USA), AMD® microprocessors (AMD is a registered trademark of Advanced Micro Devices Inc., Sunnyvale, Calif., USA), ARM® microprocessors (ARM is a registered trademark of Arm Ltd., Cambridge, UK) manufactured by a variety of manufactures such as Qualcomm of San Diego, Calif., USA, under the ARM® architecture, or the like.

The controlling structure 124 comprises a plurality of controllers, such as graphic controllers, input/output chipsets and the like, for coordinating operations of various hardware components and modules of the computing device 102/104.

The memory 126 comprises a plurality of memory units accessible by the processing structure 122 and the controlling structure 124 for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like. In use, the memory 126 is generally divided to a plurality of portions for different use purposes. For example, a portion of the memory 126 (denoted as storage memory herein) may be used for long-term data storing, for example, storing files or databases. Another portion of the memory 126 may be used as the system memory for storing data during processing (denoted as working memory herein).

The networking interface 128 comprises one or more networking modules for connecting to other computing devices or networks through the network 106 by using suitable wired or wireless communication technologies such as Ethernet, WI-FI®, (WI-FI is a registered trademark of the City of Atlanta DBA Hartsfield-Jackson Atlanta International Airport Municipal Corp., Atlanta, Ga., USA), BLUETOOTH® (BLUETOOTH is a registered trademark of Bluetooth Sig Inc., Kirkland, Wash., USA), ZIGBEE® (ZIGBEE is a registered trademark of ZigBee Alliance Corp., San Ramon, Calif., USA), 3G and 4G wireless mobile telecommunications technologies, and/or the like. In some embodiments, parallel ports, serial ports, USB connections, optical connections, or the like may also be used for connecting other computing devices or networks although they are usually considered as input/output interfaces for connecting input/output devices.

The display output 132 comprises one or more display modules for displaying images, such as monitors, LCD displays, LED displays, projectors, and the like. The display output 132 may be a physically integrated part of the computing device 102/104 (for example, the display of a laptop computer or tablet), or alternatively, it may be a display device physically separate from but functionally coupled to, other components of the computing device 102/104 (for example, the monitor of a desktop computer).

The coordinate input 130 comprises one or more input modules for one or more users to input coordinate data wherein the input modules may be touch-sensitive screens, touch-sensitive whiteboards, trackballs, computer mouse, touch-pads, or other human interface devices (HID), and the like. The coordinate input 130 may be a physically integrated part of the computing device 102/104 (for example, the touch-pad of a laptop computer or the touch-sensitive screen of a tablet), or it may be a display device physically separate from, but functionally coupled to, other components of the computing device 102/104 (for example, a computer mouse). The coordinate input 130, in some implementation, may be integrated with the display output 132 to form a touch-sensitive screen or a touch-sensitive whiteboard.

The computing device 102/104 may also comprise other inputs 134 such as keyboards, microphones, scanners, cameras, and the like. The computing device 102/104 may further comprise other outputs 136 such as speakers, printers, positioning modules for example GPS modules, and the like.

The system bus 138 interconnects various components 122 to 136 enabling them to transmit and receive data and control signals to/from each other.

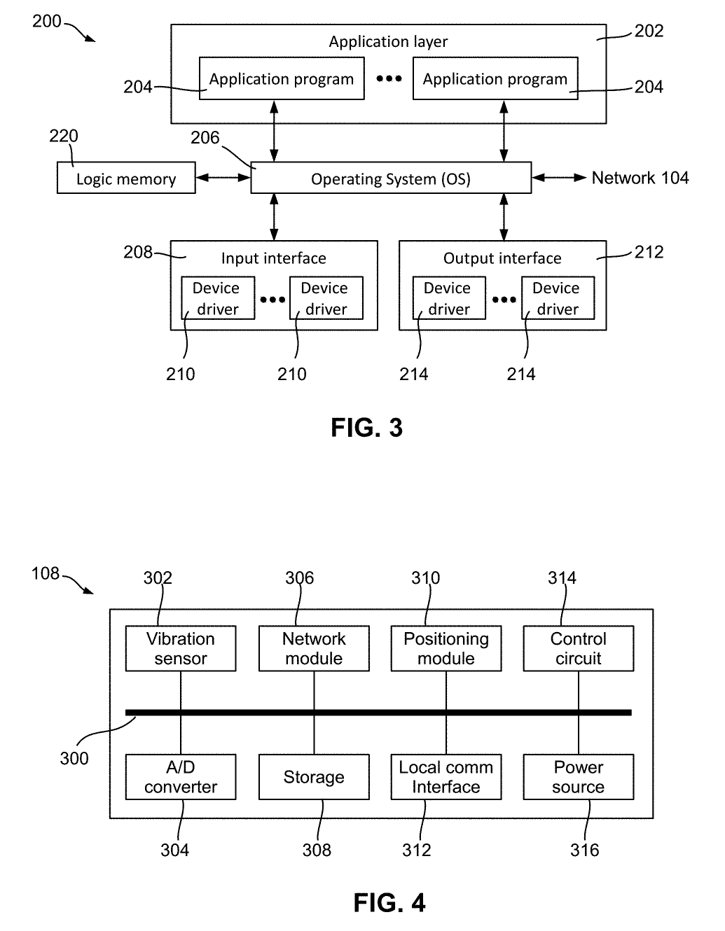

FIG. 3 shows a simplified software architecture 200 of a computing device 102/104. The software architecture 200 comprises an application layer 202, an operating system 206, an input interface 208, an output interface 212 and logic memory 220. The application layer 202 comprises one or more application programs 204 executed or run by the processing structure 122 for performing various jobs. The operating system 206 manages various hardware components of the computing device 102/104 via the input interface 208 and the output interface 212, manages logic memory 220, and manages and supports the application programs 204. The operating system 206 is also in communication with other computing devices (not shown) via the network 106 to allow application programs 204 to communicate with application programs running on other computing devices.

As those skilled in the art will appreciate, the operating system 206 may be any suitable operating system such as MICROSOFT® WINDOWS® (MICROSOFT and WINDOWS are registered trademarks of the Microsoft Corp., Redmond, Wash., USA), APPLE® OS X, APPLE® iOS (APPLE is a registered trademark of Apple Inc., Cupertino, Calif., USA), Linux, ANDROID® (ANDRIOD is a registered trademark of Google Inc., Mountain View, Calif., USA), or the like. The computing devices 102/104 of the vibration-analysis system 100 may all have the same operating system, or may have different operating systems.

The input interface 208 comprises one or more input device drivers 210 for communicating with respective input devices including the coordinate input 150. The output interface 212 comprises one or more output device drivers 214 managed by the operating system 206 for communicating with respective output devices including the display output 152. Input data received from the input devices via the input interface 208 are sent to the application layer 202, and are processed by one or more application programs 204. The output generated by the application programs 204 is sent to respective output devices via the output interface 212.

The logical memory 220 is a logical mapping of the physical memory 146 for facilitating access by the application programs 204. In this embodiment, the logical memory 220 comprises a storage memory area that is may be mapped to a non-volatile physical memory, such as hard disks, solid state disks, flash drives, and the like, for generally long-term storage of data therein. The logical memory 220 also comprises a working memory area that is generally mapped to a high-speed, and in some implementations, volatile, physical memory, such as RAM, for application programs 204 to generally temporarily store data during program execution. For example, an application program 204 may load data from the storage memory area into the working memory area, and may store data generated during its execution into the working memory area. The application program 204 may also store some data into the storage memory area as required or in response to a user's command.

In a server computer 102 or a client-computing device when acting as a server 102, the application layer 202 generally comprises one or more server application programs 204, which provide server-side functions for managing network communication with client-computing devices 104, and facilitate the vibration analysis processes.

In a client-computing device 104, the application layer 202 generally comprises one or more client-application programs 204 which provide client-side functions for communicating with the server application programs 204, displaying information and data on the graphic user interface (GUI) thereof, receiving user's instructions, and collaborating with the server application programs 204 for managing the data hubs 110 and/or the vibration-detection units 108, collecting vibration data, and the like.

The vibration-detection units 108 are usually deployed in an application field or site, and may operate continuously or intermittently to collect vibration/seismic data. Each sensing unit operates independently and transmits collected data to a receiving device via suitable wired or wireless means.

FIG. 4 is a block diagram showing the structure of a vibration-detection unit 108. As shown, the vibration-detection unit 108 in these embodiments comprises a plurality of components or modules interconnected via a bus or necessary circuit 300. In particular, the vibration-detection unit 108 comprises a vibration-detection sensor 302 such as a geophone, a MEMS sensor, or the like. The output vibration signal of the vibration-detection sensor 302 is processed by an analog-to-digital (A/D) converter 304 to convert into a digital vibration signal which is then sent to a network module 306 for communication with a receiving device such as a data hub 110 or the server computer 102 to transmit the digital vibration signal thereto. The network module 306 may use any suitable wired or wireless communication technology to communicate with the data hub 110 or the server computer 102. However, in these embodiments, it is preferable that the network module 306 uses a suitable wireless communication technology such as BLUETOOTH®, ZIGBEE®, 3G and 4G wireless mobile telecommunications technologies, and/or the like to communicate with the data hub 110 or the server computer 102.

The digital vibration signal may also be temporarily stored in a storage 308 for various purposes. For example, the digital vibration signal output from the A/D converter 304 may be temporarily stored in the storage 308 when the wireless communication module 306 fails to establish a connection with the data hub 110.

The vibration-detection unit 108 may also comprise a positioning module 310 such as a GPS module for providing the location information of the vibration-detection unit 108. Therefore, the vibration-detection units 108 may be easily relocated without the need of manually recording the locations thereof.

The vibration-detection unit 108 may further comprise a local communication interface 312 for communication with a receiving device in proximity therewith and for downloading the vibration data thereto. In some embodiments, the local communication interface 312 may be a wired connection interface such as a USB port, a HDMI port, a serial port, a parallel port, and the like. In some alternative embodiments, the local communication interface 312 may be a wireless connection interface such as a near-field communication (NFC) interface. In some embodiments, a receiving device in proximity with a vibration-detection unit 108 may also communicate with the network module 306 for downloading the vibration data.

The vibration-detection unit 108 also comprises a control circuit 314 which may be a programmable micro-controller or a suitable circuitry such as an integrated circuit (IC) for example, a field-programmable gate array (FPGA), an application-specific integrated circuit (ASIC), or the like, for controlling the operation of various modules 302 to 312, and for performing other functions such as signal processing, self-temperature monitoring and adjustment, signal quality control, clock trimming, power reservation, and/or the like. A power source 316 such as a rechargeable battery pack and/or a solar panel powers the modules 302 to 314 for extended operation times without recharging. In these embodiments, the control circuit 314 also controls the operation of the power source 316. In some embodiments, the control circuit 314 communicates with a controller device such as the server computer 102 or a client-computing device 104 through the network module 306 and via the network 106 for remotely turning the vibration-detection unit 108 on or off.

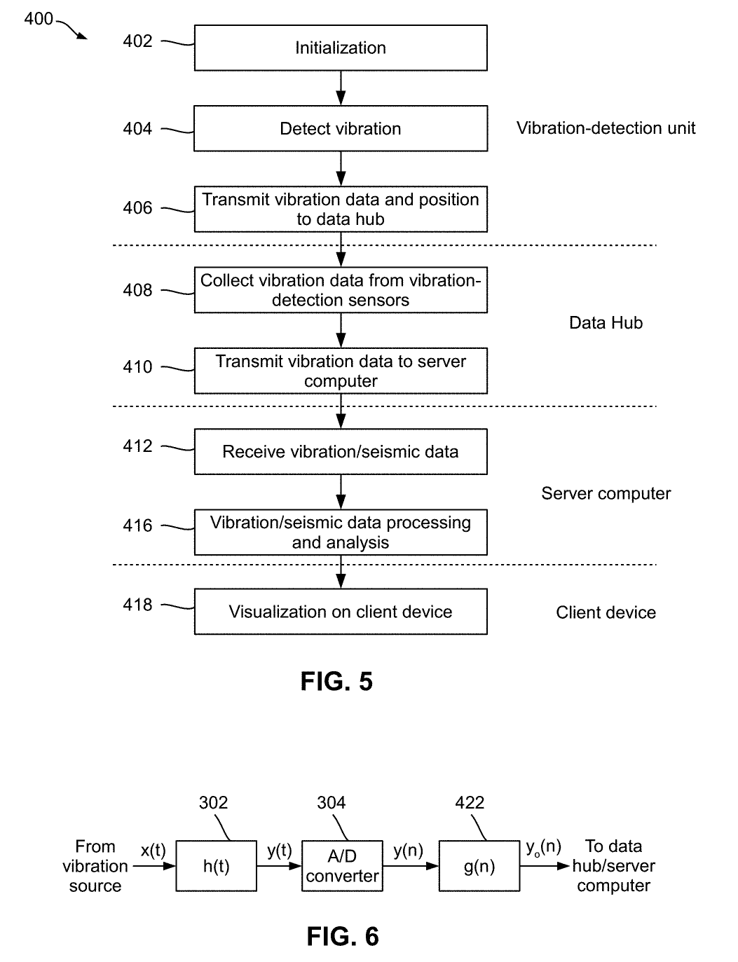

FIG. 5 is a flowchart showing the steps of a vibration/seismic survey or monitoring process 400 executed by the system 100. The process 400 starts when one or more vibration-detection sensors 302 deployed at a site are powered on and initialized (step 402). Each vibration-detection sensor 302 detects vibration (step 404) and sends the detected vibration data and the position thereof to the data hub 110 (step 406).

In various embodiments, the vibration-detection sensors 302 may continuously or intermittently send the detected vibration data and the associated position information to the data hub 110. In some embodiments, one or more of the vibration-detection sensors 302 may send the detected vibration data and the associated position information to the data hub 110 under an operator's command. For example, in one embodiment, an operator in the site may directly command a vibration-detection sensor 302 in proximity thereto to send vibration data and the associated position information to the data hub 110 by, for example, pressing a button on the vibration-detection sensor 302, sending a data-transmission command thereto via a wireless or wired direct connection between the vibration-detection sensor 302 and a computing device of the operator, and/or the like. In another embodiment, an operator of the server computer 102 may instruct the server computer 102 to send a data-transmission command to one or more vibration-detection sensors 302 for data transmission. In yet another embodiment, an operator of a client-computing device 104 may instruct the server computer 102 to send a data-transmission command to one or more vibration-detection sensors 302 for data transmission.

Each data hub 110 is functionally connected to one or more vibration-detection sensors 302 and collects data including the vibration data and the position information from the vibration-detection sensors 302 connected thereto (step 408). The data hub 110 then forwards the collected data to the sever computer 102 (step 410).

At step 412, the server computer 102 receives vibration data and the associated position information. At step 416, the server computer 102 processes the vibration data and performs vibration/seismic data analyses for various purposes such as for determining the presence of and the extent of the hydrocarbon accumulations in subterranean formations.

At this step, the server computer 102 may use various methods for vibration/seismic data analysis. For example, in one embodiment, the server computer 102 may use unsupervised clustering methods such as partition clustering, hierarchical clustering, density-based clustering, grid-based clustering, and/or the like, to process seismic facies analysis by combining different seismic attributes through pattern recognition algorithms. In this embodiment, the server computer comprises suitable spatiotemporal correlation and association rules for data-mining algorithms, and identifies correlations and association relationships among key factors.

The server computer may perform automated data processing functions by using two categories of spatial correlation measures including those from geostatistics perspectives and those from the spatial entropy perspectives. The server computer may use built-in spatial index data structures for spatial correlation calculations.

In some embodiments, the server computer 102 may use machine learning in automated machine data processing for pattern recognition. By recognizing signal data patterns, the server computer 102 tests hypotheses and applies learned results for the same patterns if the hypothesis tests have passed.

In some embodiments, the server computer 102 uses self-organized mapping (SOM) based clustering analysis for processing seismic facies data.

After data analysis and upon request from a client-computing device 104, the server computer 102 sends the results of the vibration/seismic data analysis thereto such as for visualization of the analysis results on a display of the client-computing device 104 (step 418). In some embodiments, the system 100 provides multi-interface for visualization and display. The processed data with spatial information is visualized and displayed in 2D, 3D, or motion imaging visualization, with visual reference to surface maps, subsurface maps, and geological information systems, with display adjustment and analysis capabilities.

The process 400 may be used for natural vibration/seismic detection and analysis, and may also be used for active seismic survey in which vibration/seismic signal source is usually required. As those skilled in the art will appreciate, such vibration/seismic signal source may be a conventional vibration/seismic signal source such as signals from vibroseis, explosives, and/or the like.

In some embodiments, the vibration/seismic signal source may be an unconventional source such as vibrations from one or more underground steam injectors. In these embodiments, one or more vibration-detection units 108 may be positioned on a section of steel piping connected to the steam injectors for vibration detection. The system 100 may apply correlation deconvolution to the vibration data to retrieve the source signal (i.e., the vibration signal generated by the steam injectors) by filtering the reflection and refraction signals. In one embodiment, such signal-filtering may be performed by a filter circuit in the vibration-detection unit 108. In another embodiment, such signal-filtering may be performed by the server computer 102 via, for example, a signal processing program. In yet another embodiment, such signal-filtering may be performed by the data hub 110 connected to the vibration-detection unit 108.

With the process 400, the system 100 differentiates signal components to separate subsurface seismic events, seismicity events, and ground vibration events. The processed data is used to combine with each sensing unit's position data for seismic data analysis and for generating visualization such as 2D, 3D, or motion images, with map references such as by associating the generated images with a map of the site. The visualization combines surface topography with underground events location information and subsurface structure information.

In some alternative embodiments, the vibration-detection unit 108 comprises a geophone as the vibration sensor 302, and a signal-processing module for vibration signal processing. As those skilled in the art will appreciate, the signal-processing module may be a circuit module and/or a firmware program module, depending on the implementation. FIG. 6 shows the signal flow. As shown, the geophone 302 receives a vibration/seismic signal x(t) generated by a vibration source which may be a natural vibration source such as a natural earthquake or a man-made vibration source such as an explosion or a machine vibration. The geophone 302 detects the vibration/seismic signal x(t) and outputs an output signal y(t). Generally, it is preferable that y(t) is a scaled version of x(t). That is, y(t)=Cx(t), where C is a constant for all t. However, the geophone 302 usually introduces distortion to the vibration/seismic signal x(t), and the output signal y(t) of the geophone 302 is:

y(t)=x(t)*h(t), (1)

where h(t) is the impulse response of the geophone 302, and the symbol “*” represents convolution.

As shown in FIG. 6, the output signal y(t) of the geophone 302 is fed to the A/D converter 304 which outputs a discrete-time signal y(n). In these embodiments, the vibration-detection unit 108 also comprises a signal-processing module 422 for processing y(n) to compensate for the distortion introduced by the geophone 322. The output signal yₒ(n) of the signal-processing module 422 is:

y₀(n)=y(n)*g(n), (2)

where g(n) is the discrete-time impulse response of the signal-processing module 422. The output signal yₒ(n) is then sent to the server computer 102 via the data hub 110.

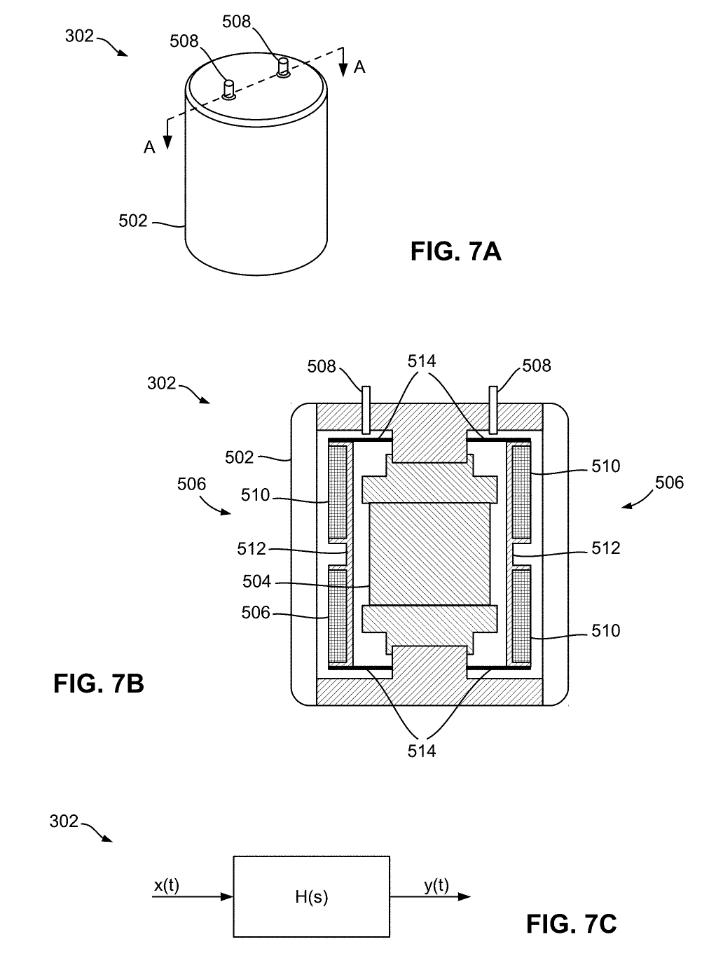

FIGS. 7A and 7B show a typical geophone 302. As shown, the geophone 302 comprises a housing 502 receiving therein a magnet structure 504, a movable coil structure 506, and electrical terminals 508 on the housing 502 for outputting vibration signals.

The magnet 504 structure is fixed to the housing 502 and forms a magnetic field therein. The movable coil structure 506 comprises one or more coil sets 510 wound on a bobbin 512 and movably suspended in the housing 502 via spring plates 514. The coil sets 510 are electrically connected to the electrical terminals 508.

The geophone 302 may be deployed in a site. When a vibration/seismic event occurs, the external vibration causes the coil structure 506 to move in the magnetic field, thereby developing an electronic voltage signal across the terminals 508. Such an electronic voltage signal is then captured and output to the server computer 102 via the data hub 110.

As shown in FIG. 7C, the geophone 302 may be modelled as a device having a s-domain transfer function H(s) that converts an input signal x(t) to an output signal y(t), i.e.,

Y(s)=X(s)H(s), (3)

where X(s) is the Laplace transform of the input signal x(t), and Y(s) is the Laplace transform of the output signal y(t), and

$$H ( s ) = A \frac{{s}^{2}}{{ms}^{2} + bs + k} \qquad ( 4 )$$

where A is the sensitivity of the geophone 302 and is determined by the multiplication of the intensity of the magnetic field of the magnet 504 and the length of the coil set 506; m is the mass of the movable coil structure 506 including the mass of the coil set 510, the mass of the bobbin 512, and the effective mass of the spring plates 514; b is the damping ratio of the spring plate 514 in air; and k is the spring constant determined by the spring plates 514.

Equation (4) may be rewritten as:

$$H ( s ) = B \frac{{s}^{2}}{{s}^{2} + 2 {ξω}_{n} s + {ω}_{n}^{2}} \qquad ( 5 )$$

where B=A/m, ωₙ=\sqrt{k/m} is the resonant angular frequency, and ξ=b/(2\sqrt{km}) is the damping coefficient. Those skilled in the art will appreciate that B, ωₙ, and ξ are predetermined design parameters.

In the following description, some examples are described. These examples show simulations of the geophone 302 with various parameters in MATLAB® and SIMULINK® (MATLAB is a trademark of MathWorks Inc., Natick, Mass., U.S.A.) and the equalization of the geophone 302 for compensation of the distortion introduced by the geophone 302.

### Example 1

In this example, the responses of a geophone 302 are simulated. The geophone 302 has a resonant frequency fₙ=ωₙ/(2π)=10 Hz and a damping coefficient ξ=0.707. Then, the transfer function of the geophone 302 is:

$$H ( s ) = \frac{{s}^{2}}{{s}^{2} + 88.84 s + 3948} \qquad ( 6 )$$

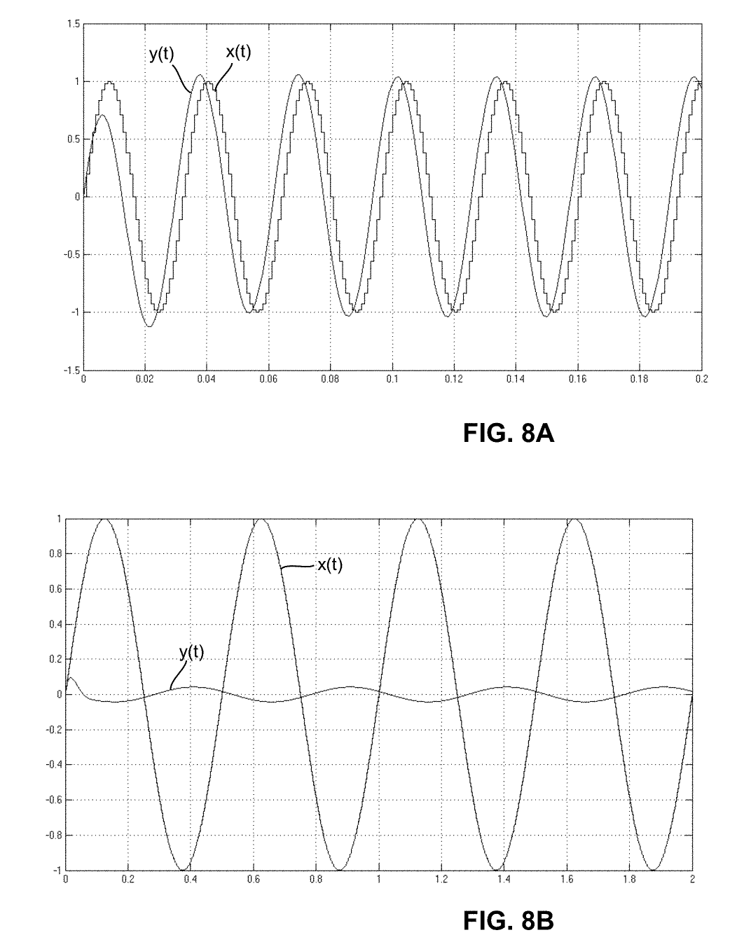

FIG. 8A shows a sinusoid input signal x(t)=sin(2πf₀t) with a frequency f₀ of 31.25 Hz input to the geophone 302, and the output y(t) thereof. As shown, the output signal y(t) is distorted.

FIG. 8B shows a sinusoid input signal x(t)=sin(2πf₀t) with a frequency f₀ of 2 Hz input to the geophone 302, and the output y(t) thereof. As shown, the output signal y(t) is distorted and significantly attenuated.

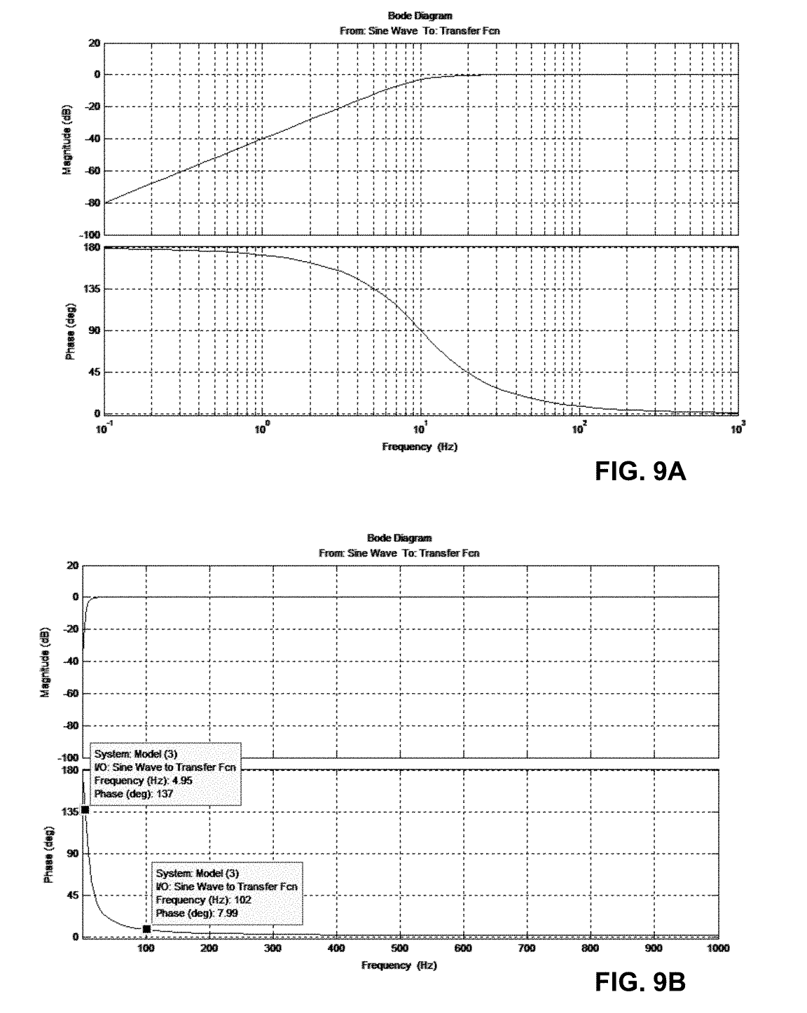

FIGS. 9A and 9B show the Bode diagram of the transfer function H(s) of the geophone 302. It can be seen that the magnitude response of the geophone 302 has about 40 dB attenuation at 1 Hz with about 12 dB attenuation per octave. Moreover, the phase response of the geophone 302 exhibits nonlinear distortion within the frequency range widely used in seismic survey, such as the frequency range between about 5 Hz and about 100 Hz. As shown in FIG. 9B, the phase response of the geophone 302 is about 137 degrees at 5 Hz and is about 8 degrees at 100 Hz.

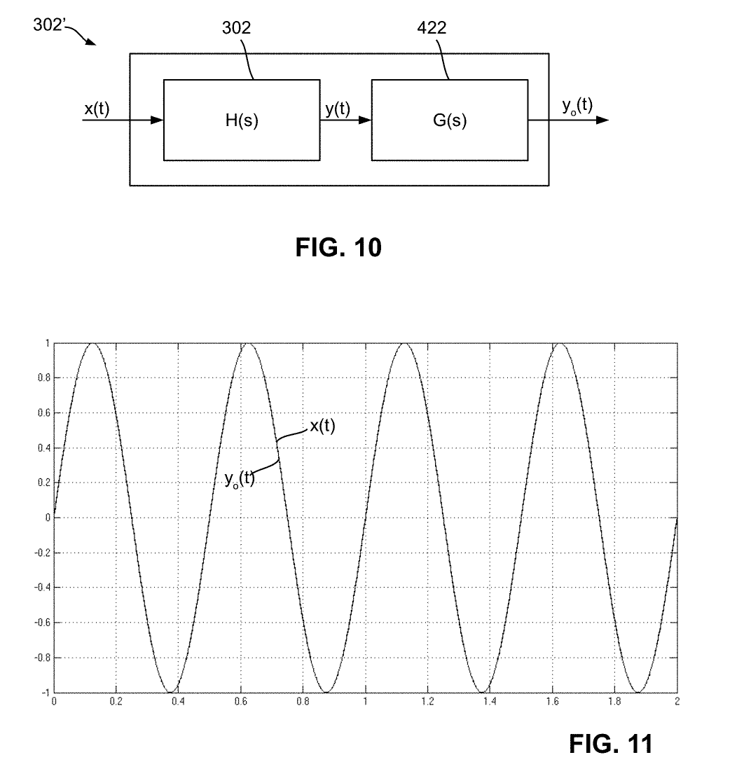

As shown in FIG. 10, to compensate for the distortion of the geophone 302, the control circuit 314 thereof comprises a signal-processing module 422 having a transfer function:

$$G ( s ) = \frac{1}{H ( s )} = \frac{{s}^{2} + 2 {ξω}_{n} s + {ω}_{n}^{2}}{{Bs}^{2}} . \qquad ( 7 )$$

Then, the overall transfer function Hₒ(s) of the equalized geophone 302′ is:

Hₒ(s)=H(s)G(s)=1. (8)

### Example 2

For the geophone 302 in Example 1, the transfer function of the signal-processing module 422 is:

$$G ( s ) = \frac{{s}^{2} + 88.84 s + 3948}{{s}^{2}} . \qquad ( 9 )$$

FIG. 11 shows a sinusoid input signal x(t)=sin(2πf₀t) with a frequency f₀ of 2 Hz input to the equalized geophone 302′, and the equalized output y₀(t) thereof. As shown, the equalized output y₀(t) substantively matches the input signal x(t).

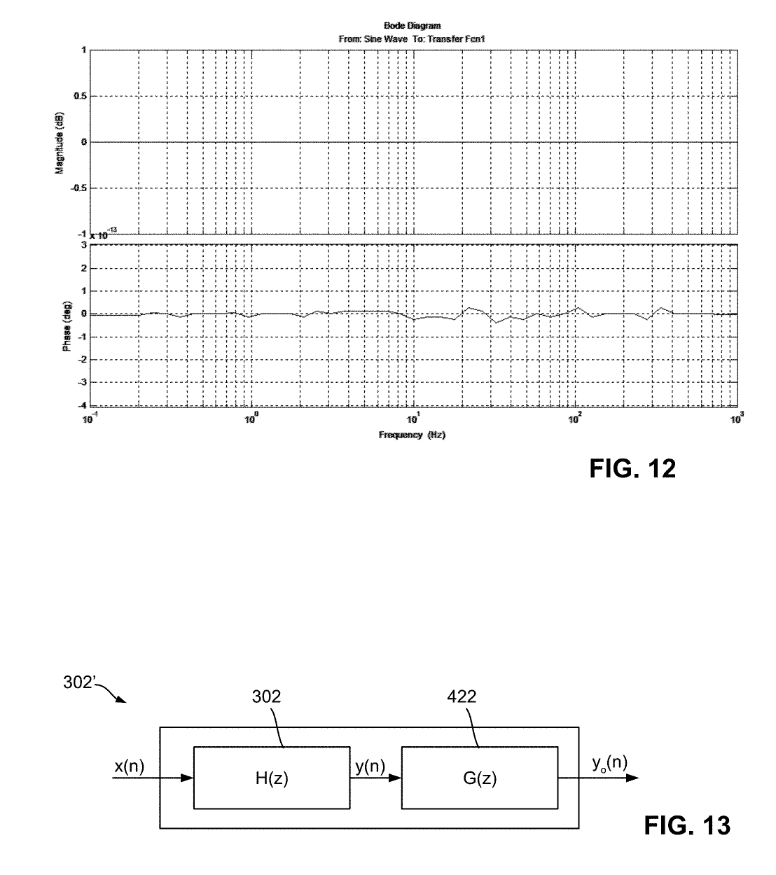

FIG. 12 shows the Bode diagram of the transfer function Hₒ(s) of the equalized geophone 302′. As can be seen, the magnitude response of the equalized geophone 302′ is substantively linear with a variation between about −0.01 dB and 0.01 dB, and the phase response thereof is also substantively linear with a maximum variation of about 10⁻¹³ degrees.

As described above, the signal-processing module 422 is implemented in discrete-time domain by converting the s-domain transfer function G(s) of the signal-processing module 422 into a (discrete-time) z-domain transfer function G(z) using a predetermined suitable sampling method such as impulse invariance, zero-order hold, first-order hold, bilinear, zero-pole matching, or the like, and a predetermined suitable sampling frequency. In other words, the z-domain transfer function G(z) is a discrete-time equivalence of the s-domain transfer function G(s) under the sampling method and the sampling frequency used.

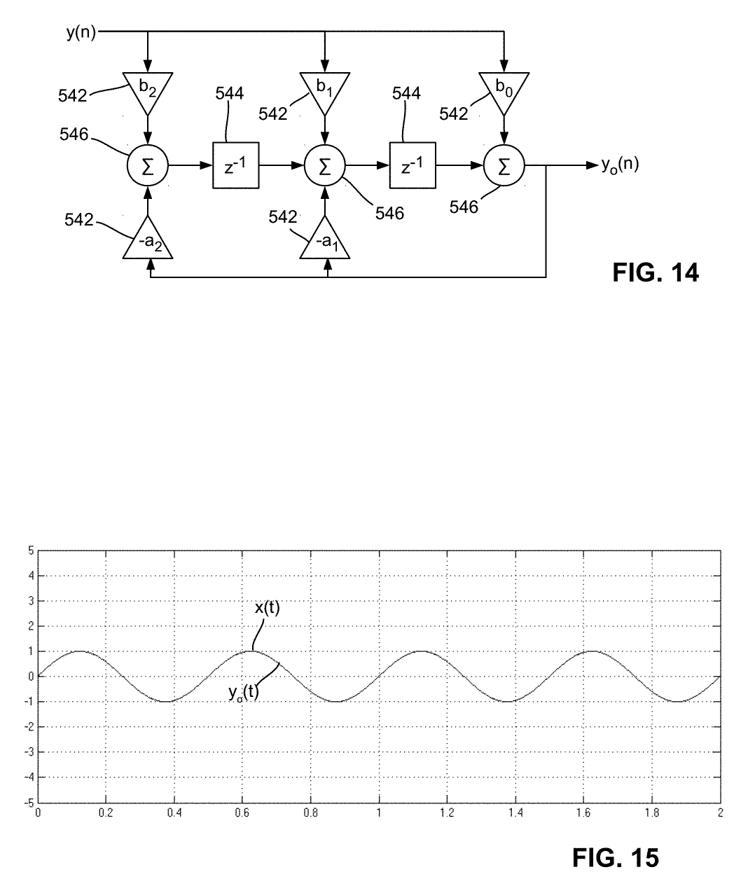

FIG. 13 shows the signal processing model in the discrete time domain. The z-domain transfer function G(z) may be written as:

$$G ( z ) = \frac{{b}_{0} + {b}_{1} {z}^{- 1} + {b}_{2} {z}^{- 2}}{1 + {a}_{1} {z}^{- 1} + {a}_{2} {z}^{- 2}} \qquad ( 10 )$$

where the parameters a₀ to a₂ and b₀ to b₂ are predetermined based on H(s), the sampling frequency, and the sampling method for discretizing H(s). As shown in FIG. 14, a direct-form II closed-loop digital filter implementation of G(z) may be obtained by using five amplifiers 542 with gains of b₂, b₁, b₀, −a₂, and −a₁, unit delays or backward-shifters 544, and adders 546.

### Example 3

In this example, the signal-processing module 422 is implemented as a digital filter with parameters having a 32-bit float-point precision. For the geophone 302 in Example 1 with a sampling frequency of 1000 Hz, the z-domain transfer function of the signal-processing module 422 is:

$$G ( z ) = \frac{1 - 1.911211772726812 {z}^{- 1} + 0.914988080796366 {z}^{- 2}}{1 - 1.998083887362504 {z}^{- 1} + 0.998083887362504 {z}^{- 2}} . \qquad ( 11 )$$

FIG. 15 shows a sinusoid input signal x(n)=sin(2πf₀n) with a frequency f₀ of 2 Hz input to the equalized geophone 302′, and the equalized output y₀(n) thereof. As shown, the equalized output y₀(n) substantively matches the input signal x(n) with a maximum magnitude response passband variation of 0.0004 dB and a maximum phase distortion of 0.15 degrees.

### Example 4

In some embodiments, the signal-processing module 422 may be implemented with parameters having a 16-bit fixed-point number format such as the Q15 format which has 15 fractional bits.

For the geophone 302 in Example 1, the z-domain transfer function of the signal-processing module 422 using the Q15 format (with a sampling frequency of 1000 Hz) is:

$$G ( z ) = \frac{32768 - 62627 {z}^{- 1} + 29982 {z}^{- 2}}{32768 - 65473 {z}^{- 1} + 32705 {z}^{- 2}} . \qquad ( 12 )$$

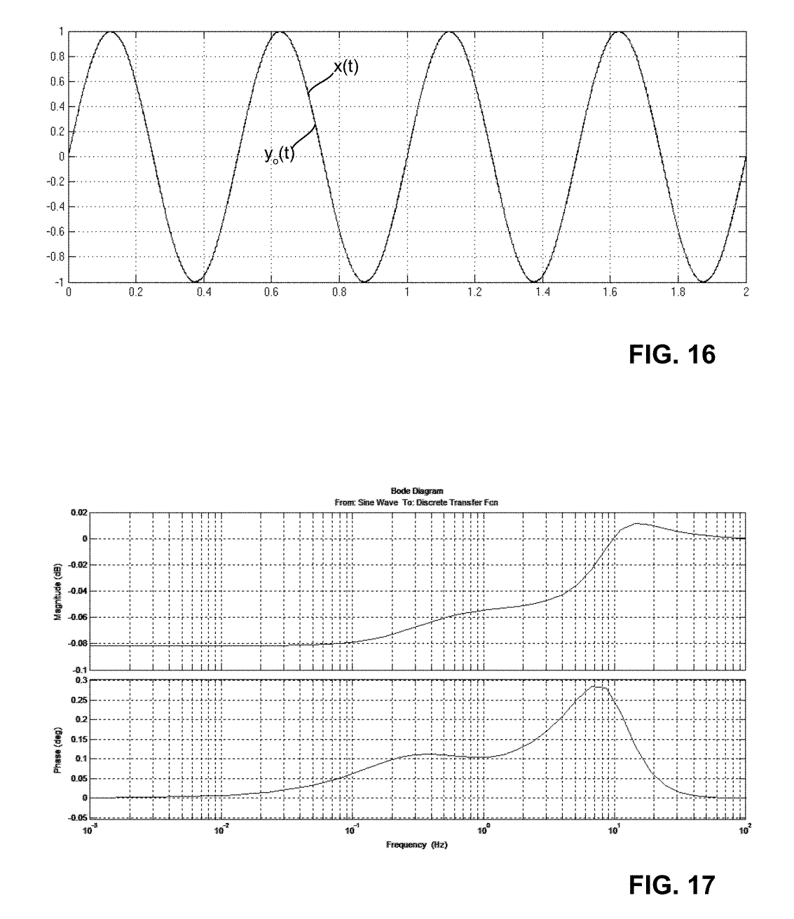

FIG. 16 shows a sinusoid input signal x(n)=sin(2πf₀n) with a frequency f₀ of 2 Hz input to the equalized geophone 302′, and the equalized output y₀(n) thereof. As shown, the equalized output y₀(n) substantively matches the input signal x(n).

FIG. 17 shows the Bode diagram of the transfer function Hₒ(s) of the equalized geophone 302′. As can be seen, the transfer function Hₒ(s) of the equalized geophone 302′ is substantively linear with a maximum magnitude-response variation of about −0.08 dB within the frequency range between 1 mHz and 302 Hz, and a maximum phase-response distortion of about 0.28 degrees, which is generally suitable for seismic survey.

### Example 5

In this example, the geophone 302 has a resonant frequency fₙ=ωₙ/(27π)=10 Hz and a damping coefficient ξ=0.6784. Then, the transfer function of the geophone 302 is:

$$H ( s ) = \frac{{s}^{2}}{{s}^{2} + 85.25 s + 3948} . \qquad ( 13 )$$

The z-domain transfer function of the signal-processing module 422 using the Q15 format (with a sampling frequency of 1000 Hz) is:

$$G ( z ) = \frac{32768 - 62734 {z}^{- 1} + 30090 {z}^{- 2}}{32768 - 65473 {z}^{- 1} + 32705 {z}^{- 2}} . \qquad ( 14 )$$

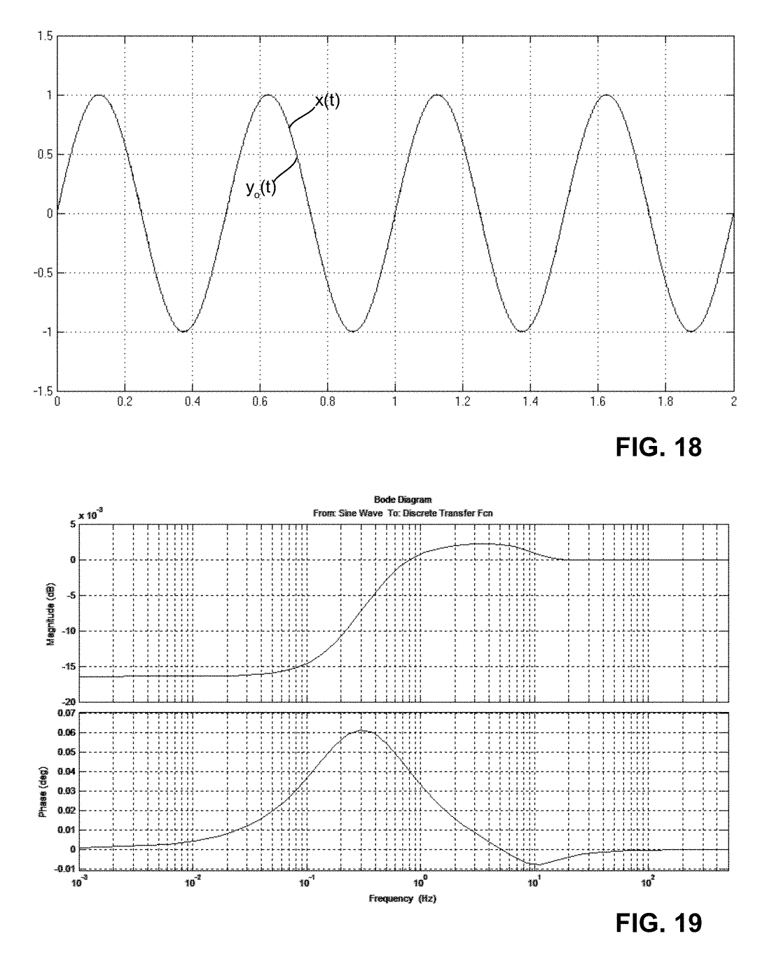

FIG. 18 shows a sinusoid input signal x(t)=sin(2πf₀t) with a frequency f₀ of 2 Hz input to the equalized geophone 302′, and the equalized output y₀(t) thereof. As shown, the equalized output y₀(t) substantively matches the input signal x(t).

FIG. 19 shows the Bode diagram of the transfer function Hₒ(s) of the equalized geophone 302′. As can be seen, the transfer function Hₒ(s) of the equalized geophone 302′ is substantively linear with a maximum magnitude-response variation of about −0.016 dB, and a maximum phase-response distortion of about 0.06 degrees.

### Example 6

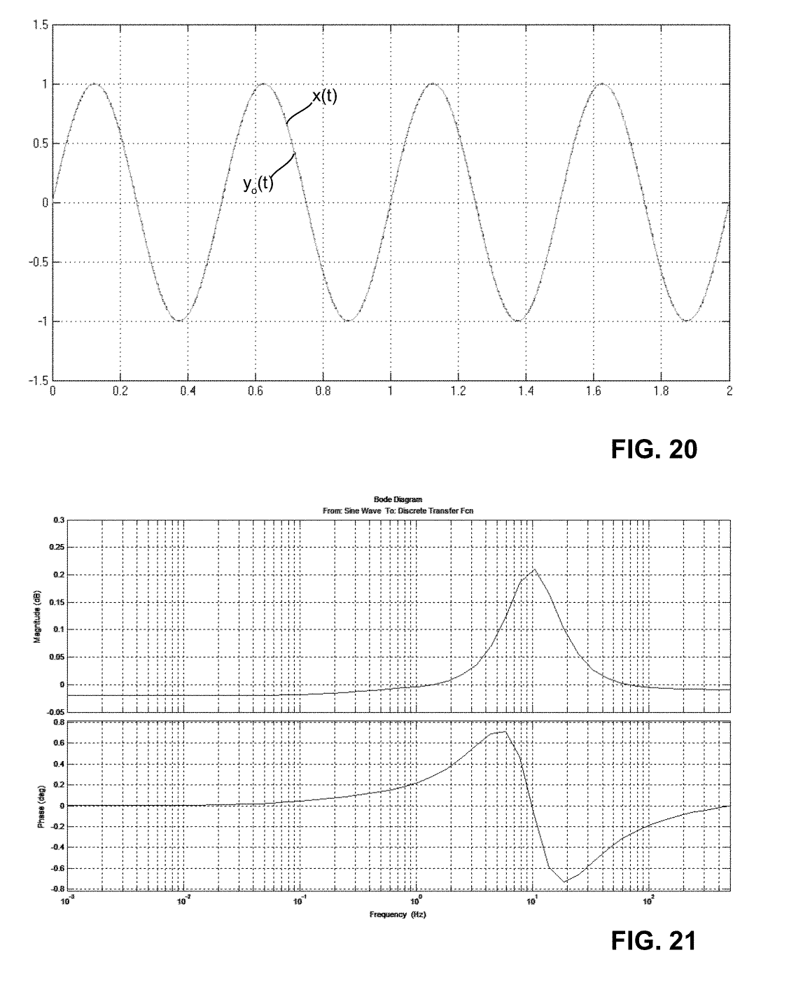

In this example, the effect of a −2.5% error in the damping coefficient is simulated. The geophone 302 and the signal-processing module 422 are as those described in Example 5. FIGS. 20 and 21 show the simulation results.

FIG. 20 shows a sinusoid input signal x(t)=sin(2πf₀t) with a frequency f₀ of 2 Hz input to the equalized geophone 302′, and the equalized output y₀(t) thereof. As shown, the equalized output y₀(t) substantively matches the input signal x(t).

FIG. 21 shows the Bode diagram of the transfer function Hₒ(s) of the equalized geophone 302′. As can be seen, the transfer function Hₒ(s) of the equalized geophone 302′ is substantively linear with a maximum magnitude-response variation of about 0.22 dB, and a maximum phase-response distortion of about 0.8 degrees.

### Example 7

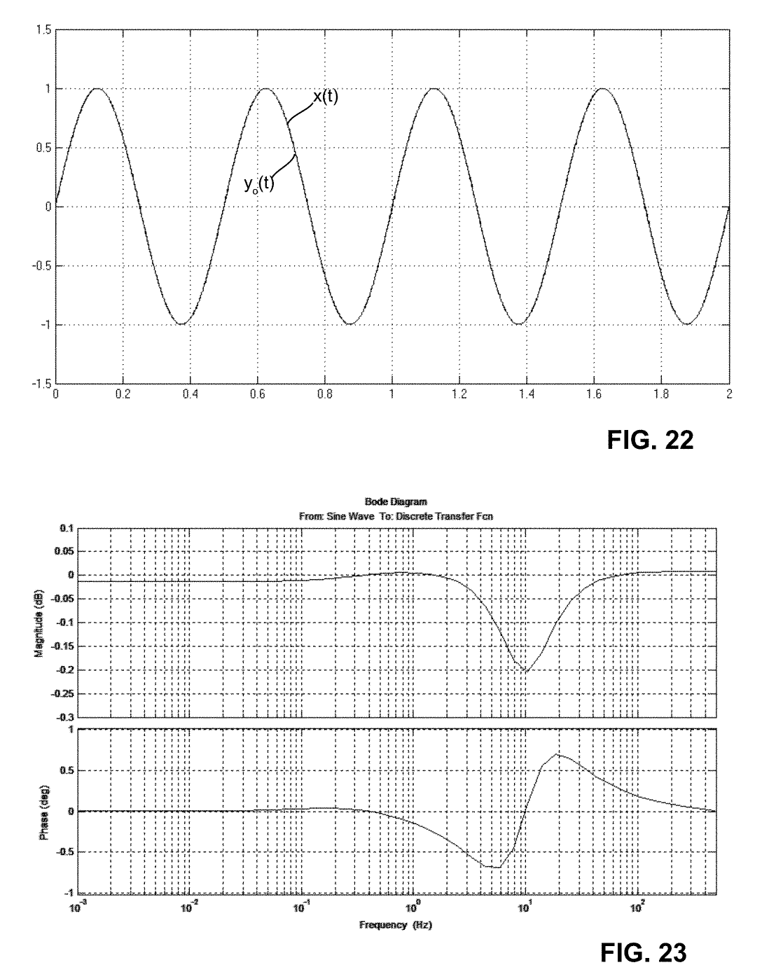

In this example, the effect of a 2.5% error in the damping coefficient is simulated. The geophone 302 and the signal-processing module 422 are as those described in Example 5. FIGS. 22 and 23 show the simulation results.

FIG. 22 shows a sinusoid input signal x(t)=sin(2πf₀t) with a frequency f₀ of 2 Hz input to the equalized geophone 302′, and the equalized output y₀(t) thereof. FIG. 23 shows the Bode diagram of the transfer function Hₒ(s) of the equalized geophone 302′.

As can be seen, the equalized output y₀(t) substantively matches the input signal x(t), and the transfer function Hₒ(s) of the equalized geophone 302′ is substantively linear with a maximum magnitude-response variation and a maximum phase-response distortion similar to those shown in FIGS. 20 and 21.

### Example 8

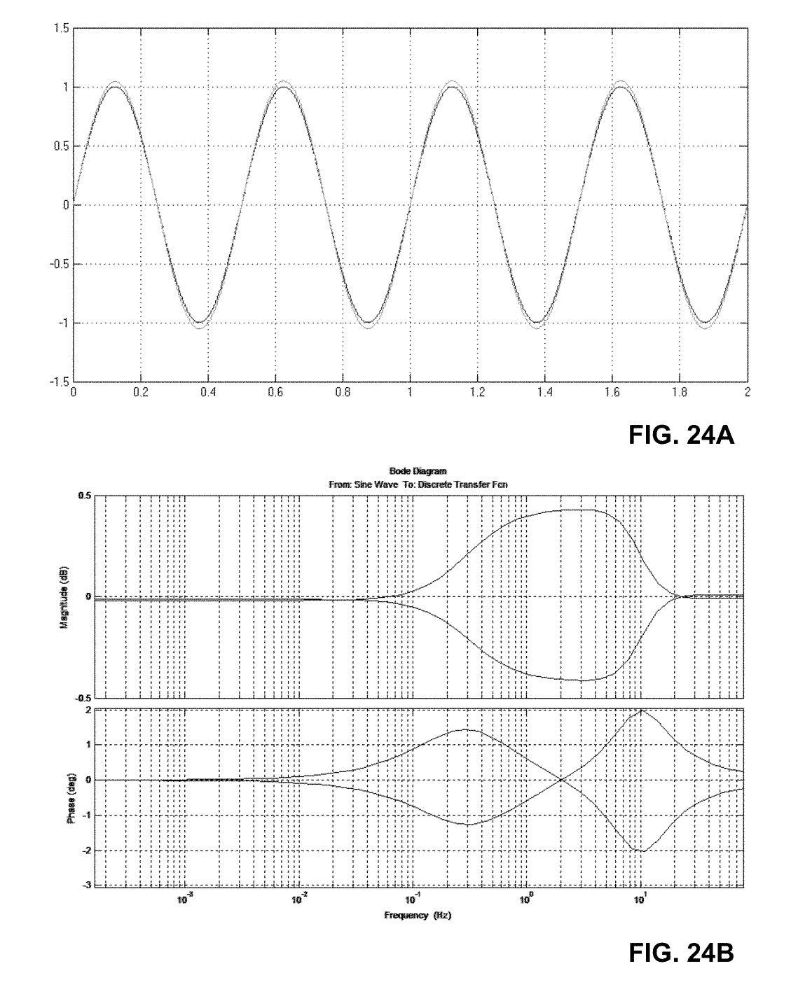

In this example, the effect of the error in the resonant frequency fₙ is simulated. The geophone 302 and the signal-processing module 422 are as those described in Example 5. FIGS. 24A to 24D show the simulation results for a ±2.5% error in the resonant frequency fₙ. FIG. 24A shows the difference in time domain between the output and a 2 Hz sinusoidal signal input, and FIG. 24B shows the maximum consequence caused by the maximum resonant frequency error to the amplitude-frequency response and phase-frequency response. As can be seen, the error in the resonant frequency fₙ mainly affects the frequency range between 0.1 Hz and 20 Hz, with a maximum magnitude-response variation of about 0.45 dB, and a maximum phase-response distortion of about 2 degrees.

Those skilled in the art will appreciate that when the parameters of the signal-processing module 422 have a precision of ±2.5%, then the magnitude-response variation in the passband is no larger than 0.45 dB and the phase-response distortion in the passband is no larger than 2 degrees. With a parameter accuracy of ±1%, the ripples in passband is less than ±0.17 dB, and the maximum phase distortion is less than 0.75 degrees.

### Example 9

In some embodiments, the signal-processing module 422 may be implemented as a software or firmware program module. The software or firmware program module may be coded using a suitable programming language and then compiled into machine-executable code or instructions. The machine-executable code or instructions may then be stored in at least one non-transitory computer-readable medium or device such as RAM, ROM, EEPROM, solid-state memory, hard disk, CD, DVD, flash memory, or the like. When a processor such as the processing structure of the server computer 102 executes the machine-executable code or instructions, the processor acts as a digital filter having the above-described z-domain transfer function G(z).

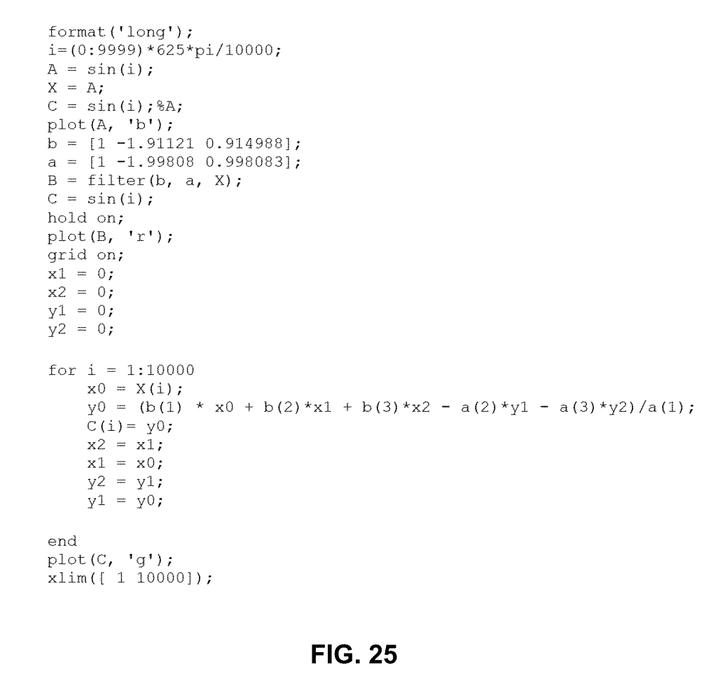

FIG. 25 shows an example of a piece of code written in MATLAB® for implementing the signal-processing module 422 for the geophone 302 in Example 1 with a sampling frequency of 1000 Hz, and for testing the signal-processing module 422 using a sinusoid input signal 602. The z-domain transfer function of the signal-processing module 422 is:

$$G ( z ) = \frac{1 - 1.91121 {z}^{- 1} + 0.914988 {z}^{- 2}}{1 - 1.99808 {z}^{- 1} + 0.998083 {z}^{2}} . \qquad ( 15 )$$

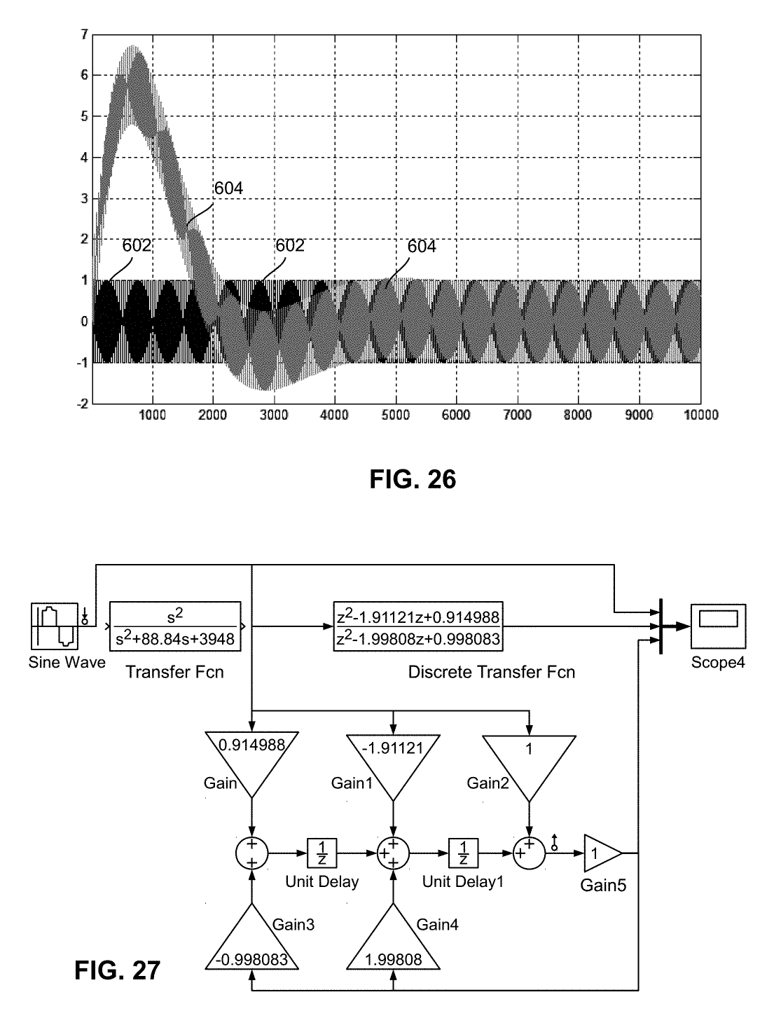

FIG. 26 shows the input signal 602 and the simulated output signal 604 of the signal-processing module 422 implemented using the code shown in FIG. 25. After an initial period of time, the output signal 604 matches the input signal 602.

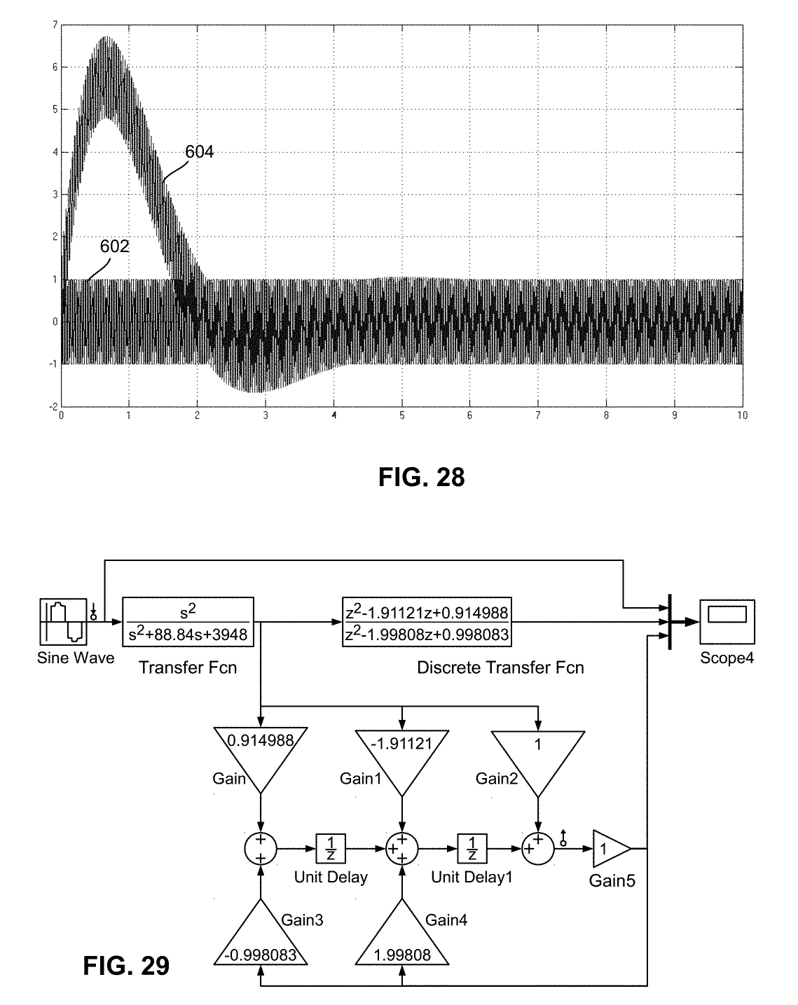

FIGS. 27 and 28 respectively show a diagram of simulating the signal-processing module 422 in SIMULINK® with a sampling frequency of 1000 Hz, and the simulation results thereof. After an initial period of time, the output signal 604 matches the input signal 602.

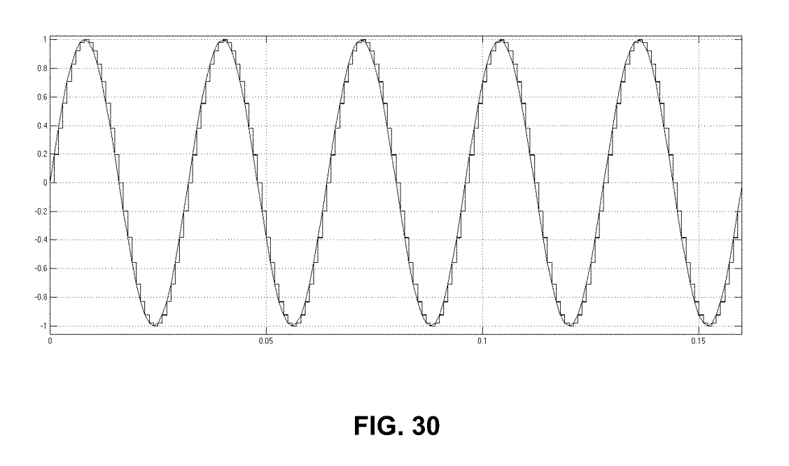

FIGS. 29 and 30 respectively show a diagram of simulating the equalized geophone 302′ (comprising the geophone 302 and the signal-processing module 422) in SIMULINK® with a sampling frequency of 1000 Hz, and the simulation results thereof. After an initial period of time, the output signal 604 matches the input signal 602. The input and output signals match each other.

In above embodiments, each vibration-detection unit 108 comprises a positioning module 310 for providing position information to the server computer 102. In some alternative embodiments, at least one vibration-detection unit 108 does not comprise any positioning module 310. In these embodiments, such a vibration-detection unit 108 is deployed at a known location, and server computer 102 stores the location thereof. In the event that such vibration-detection unit 108 is redeployed, the new position thereof may be manually obtained for updating the corresponding record stored by the server computer 102.

In above embodiments, each vibration-detection unit 108 comprises a signal-processing module 422 for compensating for the distortion introduced by the geophone 322. In some alternative embodiments, the vibration-detection unit 108 does not comprise the signal-processing module 422. Rather, the signal-processing module 422 is implemented as a software program or program module executable on the server computer 102. In these embodiments, the system 100 has advantages comparing to above embodiments such as reduced cost of the vibration-detection units 108. Moreover, the system 100 only needs one signal-processing module 422 as a signal-processing software program or program module on the server computer 102 for processing the outputs of all vibration-detection units 108. In some embodiments, the server computer 102 comprises a plurality sets of parameters of G(z) for being used by the signal-processing software program. Each set of parameters correspond to a geophone 302.

In some alternative embodiments, the signal-processing module 422 may be implemented as a software or firmware program on the data hub 110.

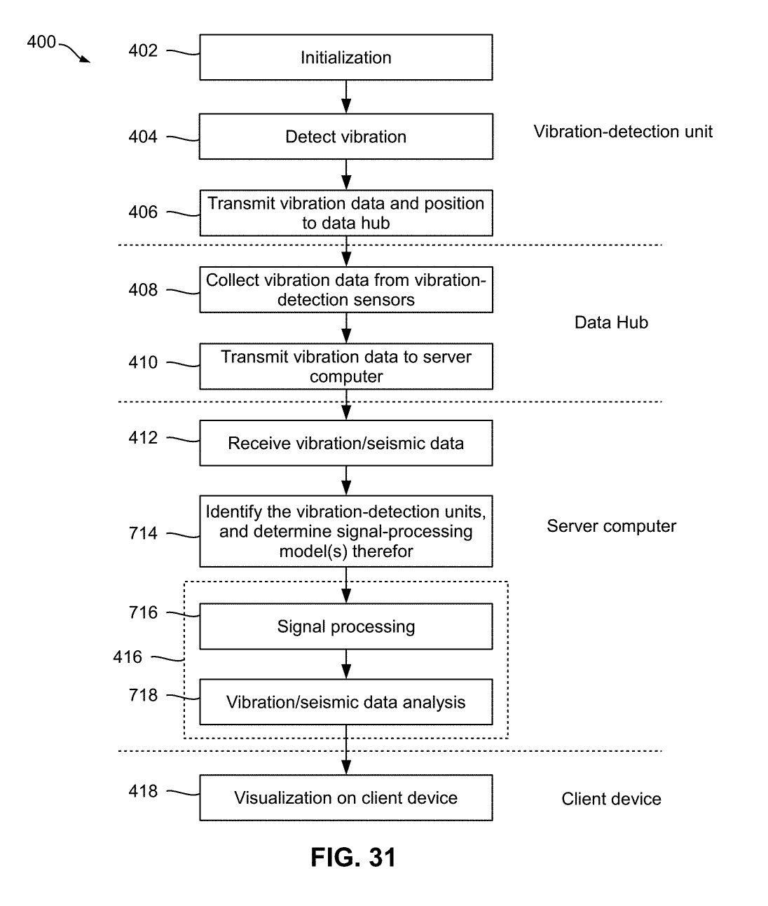

FIG. 31 shows the process 400 in these embodiments. As shown, the process 400 starts when the system initializes (step 402). In a vibration/seismic survey, the vibration-detection unit 108 detects vibration (step 404). As the vibration-detection unit 108 does not comprise any signal-processing module 422, the vibration-detection unit 108 converts the output y(t) of the geophone 302 to a digital signal y(n) via the A/D converter 304, and transmits the digital signal y(n) and the position information obtained by the positioning module 310 to the data hub 110 (step 406).

As described before, the data hub 110 collects vibration data (step 408) and transmits collected vibration data to the server computer 102 (step 410). The server computer 102 receives the vibration data (step 412). The server computer 102 then identifies the vibration-detection units 108 that the vibration data is associated therewith, and determines signal processing model(s) such as the z-domain transfer function G(z) (step 714). At this step, the server computer 102 in some embodiments may determine a separate signal-processing model such as a separate z-domain transfer function G(z) for each vibration-detection unit 108. In some other embodiments, the server computer 102 may determine a same signal-processing model such as a same z-domain transfer function G(z) for all vibration-detection units 108. In some embodiments, the vibration-detection units 108 are partitioned to different groups based on their characteristics, and the server computer 102 may determine a signal processing model such as a z-domain transfer function G(z) for each group of vibration-detection units 108.

At step 416, the server computer 102 first performs signal process (step 716) to compensate for the distortion introduced by the geophone 302 as described above, and then performs vibration/seismic data analysis (step 718). Upon request from a client-computing device 104, the server computer 102 sends the results of the vibration/seismic data analysis thereto such as for visualization the analysis results on a display of the client-computing device 104 (step 418).

The above-described vibration-analysis system 100 provides ease and convenience for deploying vibration-detection units 108 in a site for surveying and/or for vibration/seismic monitoring wherein the vibration-detection units 108 may be deployed on ground surface or underground. In some scenarios, the vibration-detection units 108 may be deployed downhole into wells or submerged under water.

In embodiments wherein the vibration-detection units 108 comprise a positioning module 310, the vibration-analysis system 100 avoids the burden of manually recording and/or updating the positions or geolocations of the vibration-detection units 108. In embodiments wherein the vibration-analysis system 100 uses the signal-processing module 422, the distortion introduced by the geophone 302 is compensated therefor, thereby obtaining high-bandwidth (such as from about 0.001 Hz to about 420 Hz) high-accuracy vibration detection results.

Although embodiments have been described above with reference to the accompanying drawings, those of skill in the art will appreciate that variations and modifications may be made without departing from the scope thereof as defined by the appended claims.

What is claimed is:

1. A vibration-detection apparatus comprising:
a geophone for detecting vibration and outputting a first signal;
an analog-to-digital (A/D) converter functionally coupled to the geophone for converting the first signal to a second signal in a discrete-time domain; and
a signal-processing module functionally coupled to the geophone for processing the second signal in discrete-time to compensate for the distortion therein introduced by the geophone;
wherein the geophone has a s-domain transfer function H(s) of
$$H ( s ) = B \frac{{s}^{2}}{{s}^{2} + 2 ξ {ω}_{n} s + {ω}_{n}^{2}}$$
where B, ωₙ, and ξ are predetermined parameters; and
wherein the signal-processing module has a z-domain transfer function G(z) obtained from a s-domain transfer function of
$$G ( s ) = \frac{{s}^{2} + 2 ξ {ω}_{n} s + {ω}_{n}^{2}}{{Bs}^{2}}$$
using a predetermined sampling method with a predetermined sampling frequency.

2. The vibration-detection apparatus of claim 1, wherein the signal-processing module is a digital filter having a plurality of amplifiers and unit delays; and wherein the signal-processing module has a z-domain transfer function G(z) as
$$G ( z ) = \frac{{b}_{0} + {b}_{1} {z}^{- 1} + {b}_{2} {z}^{- 2}}{1 + {a}_{1} {z}^{- 1} + {a}_{2} {z}^{- 2}}$$
where a₀, a₁, a₂, b₀, b₁, and b₂ are gains of the amplifiers and are predetermined based on H(s), the sampling method and the sampling frequency.

3. The vibration-detection apparatus of claim 1 further comprising:
a positioning module;
a network module; and
a control circuit functionally coupled to the geophone, the signal-processing module, the positioning module and the network module for controlling the operation thereof.

4. The vibration-detection apparatus of claim 3, wherein the positioning module is a Global Positioning System (GPS) module.

5. A vibration-detection system comprising:
at least one server computer;
one or more vibration-detection units functionally coupled to the at least one server computer via a network, each vibration-detection unit for detecting vibration and outputting vibration data, each vibration-detection unit comprising at least a geophone and an A/D converter functionally coupled to the geophone for converting the output signal of the geophone to a second signal in a discrete-time domain, the vibration-detection unit generating the vibration data based on the second signal; and
at least one signal-processing module functionally coupled to the geophone for processing the first signal in discrete-time to compensate for the distortion therein introduced by the geophone;
wherein each geophone has a s-domain transfer function H(s) of
$$H ( s ) = B \frac{{s}^{2}}{{s}^{2} + 2 ξ {ω}_{n} s + {ω}_{n}^{2}}$$
where B, ωₙ, and ξ are predetermined parameters; and
wherein the at least one signal-processing module has a z-domain transfer function G(z) obtained from a s-domain transfer function of
$$G ( s ) = \frac{{s}^{2} + 2 ξ {ω}_{n} s + {ω}_{n}^{2}}{{Bs}^{2}}$$
using a predetermined sampling method with a predetermined sampling frequency.

6. The vibration-detection system of claim 5 further comprising:
one or more data hubs, each of the one or more data hubs functionally coupled to at least one vibration-detection unit for collecting the vibration data and forwarding the collected vibration data to the at least one server computer.

7. The vibration-detection system of claim 5 further comprising:
one or more client-computing devices functionally coupled to the at least one server computer.

8. The vibration-detection system of claim 5, wherein each of the vibration-detection units comprises one of the at least one signal-processing module.

9. The vibration-detection system of claim 5, wherein each of the at least one signal-processing module is a digital filter having a plurality of amplifiers and unit delays; and wherein the signal-processing module has a z-domain transfer function G(z) of
$$G ( z ) = \frac{{b}_{0} + {b}_{1} {z}^{- 1} + {b}_{2} {z}^{- 2}}{1 + {a}_{1} {z}^{- 1} + {a}_{2} {z}^{- 2}}$$
where a₀, a₁, a₂, b₀, b₁, and b₂ are gains of the amplifiers and are predetermined based on H(s), the sampling method and the sampling frequency.

10. The vibration-detection system of claim 5, wherein the signal-processing module comprises computer-executable code executable by the at least one server computer.

11. The vibration-detection system of claim 5, wherein each vibration-detection unit further comprises:
a positioning module;
a network module; and
a control circuit functionally coupled to the geophone, the signal-processing module, the positioning module and the network module for controlling the operation thereof.

12. The vibration-detection system of claim 11, wherein the positioning module is a GPS module.

13. A computer-readable storage device comprising computer-executable instructions for processing an output signal of a geophone for compensating for the distortion therein introduced by the geophone, each geophone having a s-domain transfer function H(s) of
$$H ( s ) = B \frac{{s}^{2}}{{s}^{2} + 2 ξ {ω}_{n} s + {ω}_{n}^{2}}$$
where B, ωₙ, and ξ are predetermined parameters, wherein the instructions, when executed, cause a processor to act as a digital filter having a z-domain transfer function G(z) obtained from a s-domain transfer function of
$$G ( s ) = \frac{{s}^{2} + 2 ξ {ω}_{n} s + {ω}_{n}^{2}}{{Bs}^{2}}$$
using a predetermined sampling method with a predetermined sampling frequency.

14. The computer-readable storage device of claim 13, wherein the instructions, when executed, cause the processor to further cause the processor to perform actions comprising:
obtaining the position information of the geophone;
identifying the geophone; and
determining the transfer function G(s) based on said identification.

15. The computer-readable storage device of claim 14, wherein each geophone is associated with a positioning module; and wherein said obtaining the position information of the geophone comprises obtaining the position information of the geophone by using the positioning module associated therewith.

16. The computer-readable storage device of claim 15, wherein the positioning module is a GPS module.
